(19) United States
(12) Patent Application Publication
(10) Pub. No.: US 2009/0204912 A1
(43) Pub. Date: Aug. 13, 2009

(54) GENEERAL PURPOSE INFINITE DISPLAY CANVAS

(75) Inventors: Bradford H. Lovering, Clyde Hill, WA (US); Mohsen Agsen, Honolulu, HI (US); Randy Kimmerly, Woodinville, WA (US); Douglas Purdy, Kirkland, WA (US); Christopher L. Anderson, Redmond, WA (US); Vijaye Raji, Redmond, WA (US); Vikram Bapat, Seattle, WA (US); Steven J. Clarke, Cambridge (GB); Bryan J. Tiller, Bellevue, WA (US); Florian Voss, Seattle, WA (US); Stephen M. Danton, Seattle, WA (US); Andrew C. Wassyng, Seattle, WA (US); Laurent Mollicone, Kirkland, WA (US); James R. Flynn, Seattle, WA (US); Arwen E. Pond, Woodinville, WA (US); Robert A. DeLine, Seattle, WA (US); Gina D. Venolia, Bellevue, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 12/028,735

(22) Filed: Feb. 8, 2008

(51) Int. Cl. G06F 3/00

(52) U.S. Cl. 715/762

(57) ABSTRACT

Expanding and contracting a display screen container. Data is stored in a computer readable medium. The data represents a screen container such as a graphical desktop user interface displayable to a user on a computer display of a computing device. Data is stored representing artifacts, including one or more application graphical user interface artifacts for applications that are instantiated on the computing device. Information is stored specifying locations where each of the artifacts should be graphically located in the screen container. The graphical size of screen container is determined by the locations of the artifacts. Based on user input, a portion of the screen container is displayed to the user on the computer display of the computing device. The screen container may be expanded or contracted based on opening or closing graphical user interface artifacts, adding or removing artifacts, or repositioning artifacts.

### BACKGROUND

1. Background and Relevant Art

Computers and computing systems have affected nearly every aspect of modern living. Computers are generally involved in work, recreation, healthcare, transportation, entertainment, household management, etc.

Many computers are intended to be used by direct user interaction with the computer. As such, computers have input hardware and software user interfaces to facilitate user interaction. For example, a modern general purpose computer may include a keyboard, mouse, touchpad, camera, etc for allowing a user to input data into the computer. In addition, various software user interfaces may be available.

One software interface that many computer systems use is a desktop. The desktop provides a base screen where a computer system can graphically represent links to programs or files. The defined graphical area of the desktop may also define the graphical area where toolbars, graphical tools, or other graphical entities may be displayed. Additionally, the desktop may be used to define the area where instantiated graphical user interface program windows can be displayed.

The desktop is of a limited graphical size; typically limited by hardware screen size or virtual hardware screen size. While resolutions can be increased or decreased to change the amount of graphical artifacts that can be displayed, and additional hardware screens can be added to increase desktop size, the desktop will be limited by the size of individual screen, the resolutions that those screens can display, and the number of individual screens supported. Additionally, portions of the desktop are typically tied to a given screen and, while artifacts on the desktop can be moved to different screens, portions of the desktop itself cannot be moved to different screens.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments described herein may be directed to a screen container that can be expanded or contracted to include display artifacts. Data is stored in a computer readable medium. The data represents a screen container such as a graphical desktop user interface displayable to a user on a computer display of a computing device. Data is stored representing artifacts, including one or more application graphical user interface artifacts for applications that are instantiated on the computing device. Information is stored specifying locations where each of the artifacts should be graphically located in the screen container. The graphical size of screen container is determined by the locations of the artifacts. Based on user input, a portion of the screen container is displayed to the user on the computer display of the computing device. The screen container may be expanded or contracted based on opening or closing graphical user interface artifacts, adding or removing artifacts, or repositioning artifacts.

Embodiments may also include functionality whereby a user can interact with the screen container to determine portions of the screen container that should be displayed to a user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a screen container illustrated with contained artifacts including graphical user interface elements;

FIG. 2 illustrates the results of a zoom operation on a screen container;

FIG. 3 illustrates alternative results of an alternative zoom operation on a screen container;

FIG. 4 illustrates a graphical association of graphical user interface artifacts;

FIG. 5 illustrates a method of expanding a screen container; and

FIG. 6 illustrates a method of contracting a screen container.

### DETAILED DESCRIPTION

Some embodiments described herein are directed to displaying a screen container where the screen container has the ability to grow to an essentially unbounded size. While the size of the screen container is technically bounded including bounding by hardware constraints such as physical memory, hard drive space, and the like, for all practical purposes the screen container is unbounded as it is unlikely that a given user would interact with the screen container in a fashion which would cause the screen container to exceed the capabilities of the hardware on which the screen container is implemented. Additionally, the screen container has the ability to grow and contract depending on graphical user interface artifacts and other artifacts displayed in the screen container. Further, embodiments include functionality for allowing users to interact with the screen container to access artifacts displayed in the screen container.

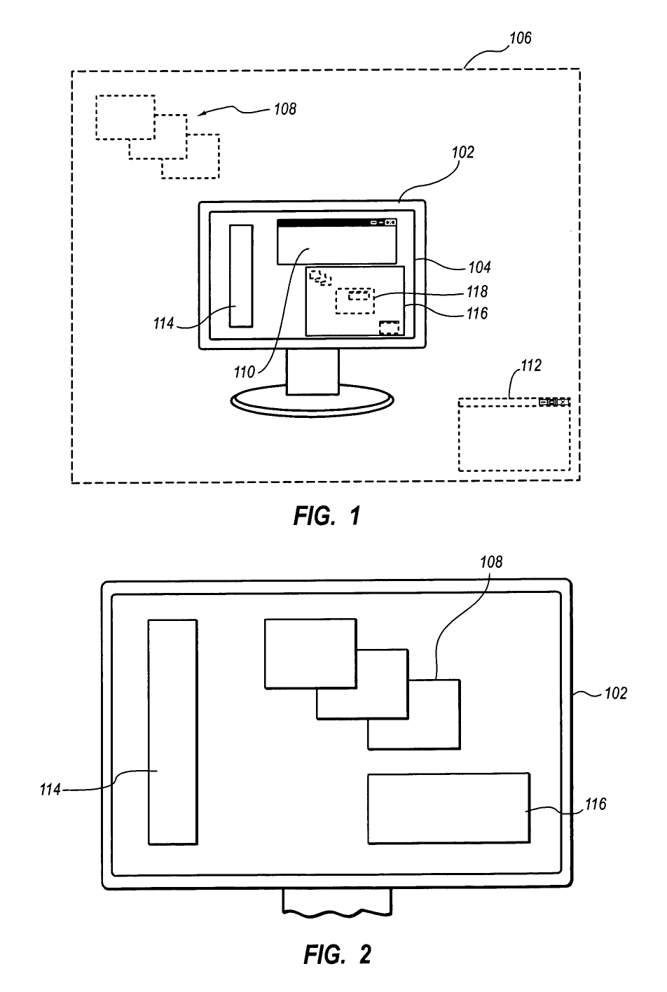

Referring now to FIG. 1, an example is illustrated. FIG. 1 illustrates a monitor 102, which may be for example a monitor such as an LCD monitor, CRT monitor, plasma display, or the like. The monitor 102 displays a portion 104 of the screen container 106. In this example, the monitor 102 is shown superimposed over the representation of the screen container 106 to illustrate that the monitor shows a given portion 104 of the screen container. The monitor may display the portion 104 as a result of interaction with a computer system, such a computer system that includes appropriate hardware such as a video adapter, memory, and other appropriate display hardware. In the example shown, the screen container 106 is a desktop graphical user interface used for displaying artifacts including: links or icons with links to programs or files, toolbars, tools, instantiated graphical user interface windows, and the like. FIG. 1 illustrates that the screen container 106 includes a group 108 of graphical user interface artifacts, a graphical user interface window artifact 110, another graphical user interface window artifact 112, the toolbar artifact 114 and a map view artifact 116. While a limited number of graphical user interface artifacts have been illustrated here, it should be appreciated that any of a number of different graphical user interface artifacts or other artifacts may be implemented in the screen container 106.

While not physically displayed on the monitor 102, artifacts, such as the artifacts contained in the grouping 108 or the graphical user interface window 112, may be stored such that they are available for display at a subsequent appropriate time. For example, information representing elements of the group 108 or the graphical user interface window 112 may be stored in physical memory, on a computer mass storage such as a hard drive or flash drive, or in any other appropriate manner.

In the example shown, the screen container 106 is shown to be of a size sufficient to contain each of the instantiated artifacts contained in the screen container 106. Notably, embodiments may be implemented to allow the screen container 106 to grow or contract as artifacts are added, removed, or moved with respect to the screen container. For example, a user may be able to drag one or more graphical user interface artifacts beyond the boundaries currently established for the screen container 106. In response, the screen container 106 would grow so as to extend the boundaries of the screen container 106 to include the moved artifacts. Similarly, new artifacts may be added, such as by instantiating a program instance (e.g. opening a program), or by adding links, icons, toolbars, etc. Added artifacts may be moved beyond the bounds presently established for the screen container 106. Additionally, embodiments may be implemented where if artifacts are moved further inward from the screen container boundaries, then the screen container 106 may contract its boundary size based on the movement of the artifact. Similarly, the screen container 106 may contract when artifacts are removed such as by closing an instantiated user interface instance, deleting a link or icon, etc.

In the example illustrated in FIG. 1, the screen container 106 includes a map view 116. The map view 116 displays a representation of one or more of the artifacts contained in the screen container 106. This allows a user to have some sense of where individual artifacts may be contained in the screen container 106. Additionally, interaction with the map view 116 may allow a user to perform various panning functions, various zooming functions, and the like. For example, the map view 116 may include a highlighting cursor 118 which a user may place over different portions of the map view 116 to select portions of the screen container 106 that are to be displayed on the viewable portions of the monitor 102. In an alternative embodiment, the user may interact with the map view 116 by performing a drag operation where a user selects a portion of the screen using mouse clicks and dragging gestures. In yet another alternative embodiment, the user may use keyboard keystrokes to select defined portions of the map view 116. For example, artifacts in the screen container 106 may be individually defined as entities, or a group of artifacts may be defined as an entity. A user may then use alt-tab functionality to scroll through different entities represented in the map view 116. Various other interactions with the map view 116 may be implemented to access portions of the screen container 106 for display.

In the example illustrated in FIG. 1, the map view 116 is displayed in a heads up display (HUD) mode. In the HUD mode, artifacts are statically displayed on the display portion of the monitor 102 with respect to other movements of the screen container 106. For example, if the portion of the screen container 106 that is displayed on the monitor 102 were changed such as by interacting with the map view 116, by grabbing and dragging the screen container 106, or by other keyboard or mouse interaction causing a change in the portion of the screen container 106 displayed on the monitor 102, the map view 116 would remain static and be displayed on the same portion of the monitor display 102 as is illustrated in FIG. 1. Nonetheless, the map view 116 may be moved to a different portion of the display of the monitor 102 such as by user interaction with the map view artifact 116 such as by grabbing and dragging the Map view 116 to a different portion of the display of the monitor 102.

Other artifacts may also be displayed in a HUD mode as a default behavior or as defined by a user. For example, it may be useful to display the toolbar 114 in a HUD mode to allow the functionality of the displayed tools to be readily available to a user. Additionally, in some embodiments, a user may select certain graphical user interface windows to be displayed in a HUD mode such that the graphical user interface windows remain static with respect to other movements of the screen container 106 on the monitor 102. In some embodiments, graphical user interface artifacts displayed in HUD mode may be excluded from the map view 116. This may be done to conserve display space on the map view 116 or to reduce clutter on the map view 116 as the user interface artifacts are already displayed to the user in the portion 104.

Additionally, HUD artifacts can be displayed in a number of different fashions. For example HUD artifacts may be displayed such that they are in front of other artifacts displayed on a screen. Alternatively, HUD artifacts may be displayed such that they are behind other artifacts displayed on the screen. Notably, in some embodiments, some HUD artifacts may be displayed in front of other artifacts while other HUD artifacts may be displayed behind other artifacts. HUD artifacts may be displayed on various levels in-front of or behind each other or other artifacts. HUD artifacts may, alternatively, be displayed in a ghost or transparent mode such that artifacts may be viewed together with HUD artifacts occupying the same display space.

As alluded to previously, some embodiments may include functionality for various panning and zooming operations. One such zooming operation may include a zoom to artifact operation. For example, a user may indicate a desire to zoom to a graphical user interface window. The displayed portion of the monitor 102 illustrated in FIG. 1 illustrates an example of what a screen on the monitor 102 might look like after an operation zooming to the graphical user interface window 110. In this example, items displayed in the HUD mode, such as the toolbar 114 and the map view 116, are static in the displayed portion of the monitor 102 such that the remaining portions of the monitor 102 display can be used to display the graphical user interface window 110. In other embodiments, zooming to an artifact may cause the zoomed to artifact to be displayed over or under HUD mode graphical user interface artifacts.

Embodiments may further implement other functionality similar to the zooming to an artifact. For example, embodiments may implement functionality whereby zooming is performed to a group such as the group 108 illustrated in FIG. 1. FIG. 2 illustrates an example of the resultant display on the monitor 102 following a user interaction directing the zoom operation to the group 108. To facilitate zooming to a group, various functionality features may be implemented. For example, embodiments may be implemented which allow user input to group artifacts together in a group. In an alternative embodiment, functionality may be implemented whereby grouping is performed automatically without user intervention based on any of a number of different factors. For example, grouping may be performed automatically based on artifacts being children of the same parent user interface. Examples of parent and child user interfaces will be discussed in more detail below. Grouping may be performed automatically by grouping instances of the same application graphical user interface together. Other grouping determinations may also be made.

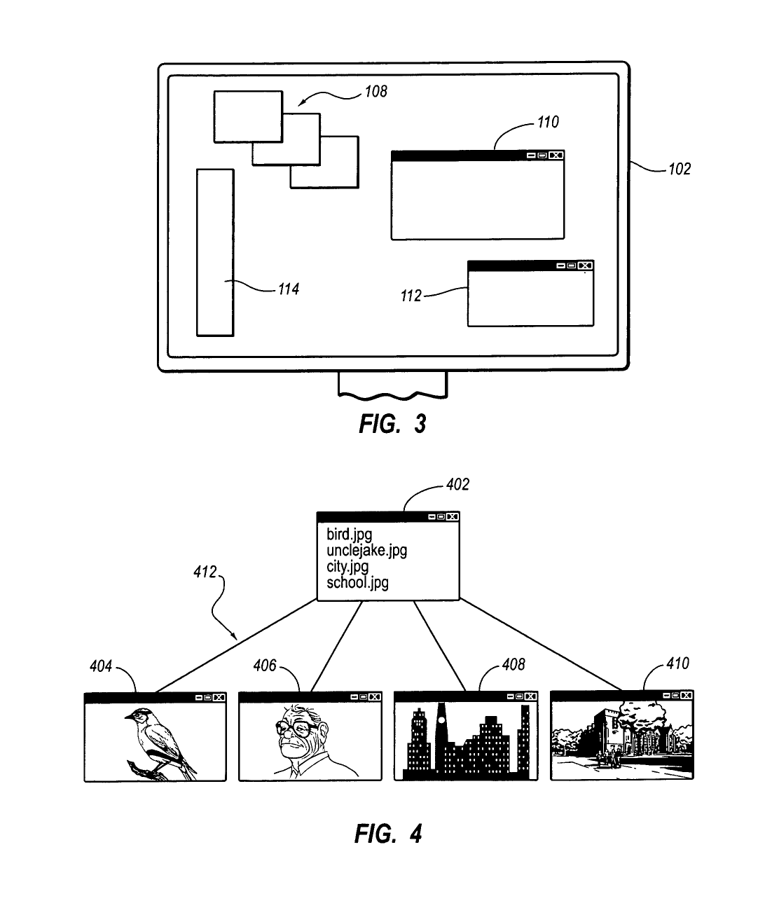

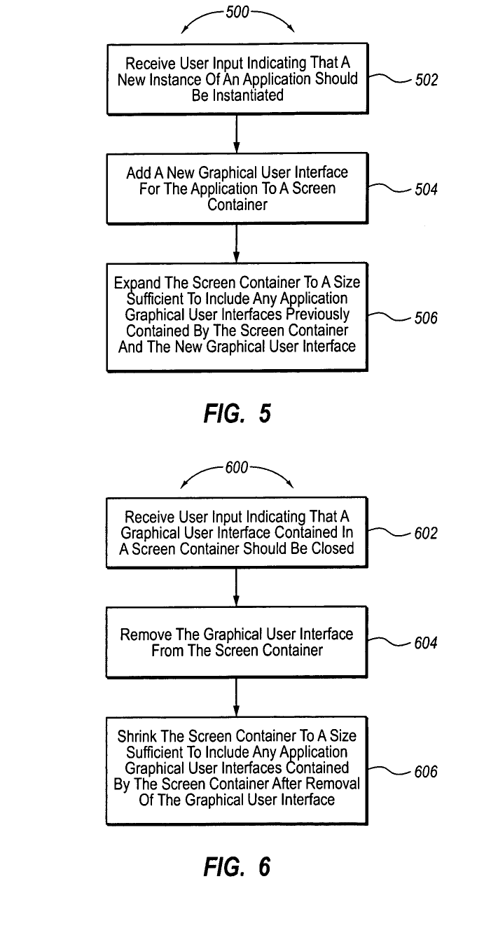

Embodiments may further implement functionality for zooming to bounds. Zooming to bounds allows all of the artifacts in the screen container 106 to be displayed on the monitor display 102. FIG. 3 illustrates an example of the display 102 after a zoom to bounds operation has been requested by a user. In this example, the map view 116 is eliminated as it would be redundant. However, other embodiments may continue to display the map view.

Further functionality may be implemented to facilitate navigating the screen container 106. For example, various book marking techniques may be used to bookmark portions of the screen container 106. Illustratively, the user may select a portion of the screen container 106 and assign a bookmark to that portion. In one embodiment, a snapshot may be taken of a portion of the screen container 106 and used as a thumbnail image or other image to facilitate zooming to the bookmarked portion. Bookmarks may be accessed in a number of different ways including but not limited to keystrokes, selection from a drop down menu, selection from a link included on a toolbar such as the toolbar 114, or by other means.

Embodiments may further include functionality for grouping child and parent graphical user interfaces. For example as discussed above, child graphical user interfaces may be grouped together such that zoom operations can be performed whereby a selected group of graphical user interface artifacts is displayed. In one embodiment, functionality is included for graphically associating parent and child graphical user interface artifacts. FIG. 4 illustrates an example where a parent artifact 402 is graphically associated with child graphical user interface artifacts 404, 406, 408, 410. Illustrating examples of where this may be useful, the graphical user interface artifact 402 may represent a root directory, which may include entries for other directories or files. When user input is received at the parent graphical user interface artifact 402, a child graphical user interface artifact, e.g. graphical user interface artifact 404, may be instantiated. Instantiation of the child graphical user interface artifact 404 allows for appropriate information to be displayed. For example, if a user interacts with the parent graphical user interface artifact 402 to open the directory, then the child graphical user interface artifact 404 will display the contents of the directory selected by the user. FIG. 4 illustrates that a line 412 graphically associates the parent a graphical user interface artifact 402 with a child graphical user interface artifact 404. In an alternative embodiment where interaction with the parent graphical user interface artifact 402 results in opening a file for display, the child graphical user interface artifact may include display elements for an application used to display the data in the file selected by the user from the parent graphical user interface 402. In the examples shown in FIG. 4, a picture viewing application may be opened to display images where file names, thumbnails, or other indicators for the images are included in the parent graphical user interface 402.

Embodiments may further be implemented using multiple monitor systems. For example, different portions of the screen container 106 may be displayed on different viewable portions of different monitors. Nonetheless, using panning and scrolling techniques, such as those described herein, or that are otherwise suitable, portions of a screen container that were previously displayed on one monitor may be zoomed or panned to on another monitor.

In one embodiment, to accomplish the above functionality, data may be stored in a computer readable medium, where the data represents a graphical desktop user interface displayable to a user on a computer display of a computing device. The computer readable medium may be any appropriate computer readable medium including physical memory, flash memory, hard disk drive storage, or other appropriate storage. Additionally, data may be stored representing artifacts, including at least one application graphical user interfaces for applications that are instantiated on the computing device. For example, in the example illustrated in FIG. 1, data may be stored which represents the desktop (e.g screen container 102), and data may be stored that represents application interfaces (e.g. interfaces 110 and 112).

Additionally, information may be stored specifying locations where each of the artifacts should be graphically located in the graphical desktop user interface. For example, information may specify that the graphical user interface 112 is located at the bottom right hand portion of the screen container 102. This is typically accomplished using a property attached to the graphical user interface 112 specifying a coordinate of the screen container 102. The graphical size of the graphical desktop user interface is determined by the locations. In the example illustrated, the size of the screen container 102 is determined by where application graphical user interfaces are located. For example, the placement of the group 108, the toolbar 114, the interfaces 110 and 112 and the map view 116 determine the size of the screen container 102.

Notably, user interaction may specify that a graphical user interface be placed beyond the coordinates available in the screen container 102. In this case, the screen container will be expanded to include the coordinates that were previously beyond the available coordinates. Similarly, movement of graphical user interfaces from the border of the screen container 102 may result in contracting of the screen container. Notably various alternative embodiments may be implemented. In one embodiment, the screen container is only of a sufficient size to contain any artifacts including any instantiated graphical user interfaces. In other embodiments, the screen container may include additional graphical space as a buffer or border that extends beyond what is needed to contain any instantiated artifacts.

As described previously, based on user input, a determination may be made regarding a portion of the graphical desktop user interface to be displayed to a user. The determined portion is then displayed to the user on the computer display of the computing device. Various user inputs may be used in the determination process. For example, in one embodiment, user input specifies zooming to a view of the screen container sized to show all artifacts contained by the screen container. An example of this is illustrated in FIG. 3. In an alternative embodiment, user input specifies zooming to a view of the screen container sized to display a selected artifact. An example of the result of this is illustrated in FIG. 1. In yet another alternative embodiment, user input specifies zooming to a view of the screen container which is sized to display a group of artifacts grouped together. An example of this is illustrated in FIG. 2. Notably, user input may specify zooming to a view of the screen container as defined by the user input at a map view as discussed previously.

Embodiments will now be illustrated illustrating a number of methods that may be used. While the methods may be described in certain orders, the method acts do not necessarily need to be performed in those orders, unless otherwise indicated. One method 500 may be practiced in a computing environment, and includes acts for presenting graphical user interfaces for a number of application instances. The method includes receiving user input indicating that a new instance of an application should be instantiated (act 502). For example, a user may select a link, icon, or other interaction to indicate that an application should be instantiated. For example, in FIG. 4, a user double clicking the link bird.jpg indicates a desire to instantiate a graphical user interface 404 for displaying the bird image represented by bird.jpg.

The method 500 further includes an act of adding a new graphical user interface for the application to a screen container (act 504). The method 500 further includes expanding the screen container to a size sufficient to include any artifacts previously contained by the screen container and the new graphical user interface. For example, in FIG. 1, if a graphical user interface is added to the screen container 106 and is positioned in a position beyond the present bounds of the screen container 106, the screen container will be expanded to include the new graphical user interface, as well as the graphical user interfaces 108, 114, 110, 116, and 112 already contained in the screen container 106.

Embodiments of the method 500 may also be implemented to implement various zooming and panning functions. For example the method 500 may further include, in response to user input, zooming to a view of the screen container sized to show all artifacts contained by the screen container. An example of screen appearance after this operation is illustrated in FIG. 3. The method 500 may further include, in response to user input, zooming to a view of the screen container sized to display a selected artifact. An example of screen appearance after this operation is illustrated in FIG. 1. The method 500 may further include in response to user input, grouping a number of artifacts together into a group. Group 108 illustrates a group of graphical user interfaces grouped together in a group. Further, FIG. 4 illustrates a group that includes a graphical indication of the grouping. When groups of artifacts are included in a screen container, the method 500 may include in response to user input, zooming to a view of the screen container which is sized to display the group. An example of screen appearance after this operation is illustrated in FIG. 2.

As described previously, a map view, such as map view 116 may be displayed. The map view includes representations of artifacts contained by the screen container. In these embodiments, the method 500 may further includes receiving user input at the map view and zooming to a view of the screen container defined by the user input at the map view. For example, a user may select a portion of the map view 116 to initiate a zoom to a corresponding portion of the screen container 102.

Another method 600 is illustrated in FIG. 6. The method 600 is a complementary method that includes acts for presenting graphical user interfaces for a number of application instances, and more especially when application instances are closed and removed. The method 600 includes receiving user input indicating that a graphical user interface contained in a screen container should be closed (act 602). The graphical user interface is removed from the screen container (act 604). The screen container is shrunk to a size sufficient to include any artifacts contained by the screen container after removal of the graphical user interface.

Embodiments herein may comprise a special purpose or general-purpose computer including various computer hardware, as discussed in greater detail below.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of presenting artifacts including one or more graphical user interfaces for one or more application instances, the method comprising:
receiving user input indicating that a new instance of an application should be instantiated;
adding a new graphical user interface for the application to a screen container; and
expanding the screen container to a size sufficient to include any artifacts previously contained by the screen container and the new graphical user interface.

2. The method of claim 1, further comprising, in response to user input, zooming to a view of the screen container sized to show all artifacts contained by the screen container.

3. The method of claim 1, further comprising, in response to user input, zooming to a view of the screen container sized to display a selected artifact.

4. The method of claim 1, further comprising in response to user input, grouping a plurality of artifacts together into a group.

5. The method of claim 4, further comprising, in response to user input, zooming to a view of the screen container which is sized to display the group.

6. The method of claim 1, further comprising displaying a map view, the map view comprising representations of one or more artifacts contained by the screen container.

7. The method of claim 6, further comprising receiving user input at the map view and zooming to a view of the screen container defined by the user input at the map view.

8. The method of claim 1, further comprising displaying one or more of the artifacts in a heads up display such that the artifacts remain statically displayed when panning or zooming to other portions of the screen container.

9. The method of claim 1, further comprising graphically associating one or more child graphical user interfaces with a parent graphical user interface.

10. The method of claim 1, wherein the screen container comprises a graphical user interface representing a computer desktop.

11. The method of claim 1, wherein the new graphical user interface and the artifacts previously contained in the screen container comprise graphical user interfaces for information displaying applications.

12. The method of claim 1, further comprising, in response to user input, zooming to a view of the screen container defined by a book mark.

13. In a computing environment, a method of presenting graphical user interfaces for a plurality of application instances, the method comprising:
receiving user input indicating that a graphical user interface contained in a screen container should be closed;
removing the graphical user interface from the screen container; and
contracting the screen container to a size sufficient to include any application graphical user interfaces contained by the screen container after removal of the graphical user interface.

14. The method of claim 13, further comprising, in response to user input, zooming to a view of the screen container sized to show all artifacts contained by the screen container.

15. The method of claim 13, further comprising, in response to user input, zooming to a view of the screen container sized to display a selected artifact.

16. In a computing environment, a method of displaying a portion of a graphical desktop user interface, the method comprising:
storing data in a computer readable medium, the data representing a graphical desktop user interface displayable to a user on a computer display of a computing device;
storing data representing artifacts including one or more application graphical user interface artifacts for applications that are instantiated on the computing device;
storing information specifying locations where each of the artifacts should be graphically located in the graphical desktop user interface, wherein the graphical size of the graphical desktop user interface is determined by the locations;
based on user input, determining a portion of the graphical desktop user interface to be displayed to a the user; and
displaying the determined portion to the user on the computer display of the computing device.

17. The method of claim 16, wherein the user input specifies zooming to a view of the screen container sized to show all artifacts contained by the screen container.

18. The method of claim 16, wherein the user input specifies zooming to a view of the screen container sized to display a selected artifact.

19. The method of claim 16, wherein the user input specifies zooming to a view of the screen container which is sized to display a group of artifacts grouped together.

20. The method of claim 16, wherein the user input specifies zooming to a view of the screen container defined by the user input at a map view.
